(19) United States
(12) Patent Application Publication
(10) Pub. No.: US 2018/0204203 A1
(43) Pub. Date: Jul. 19, 2018

(54) System for Managing and Handling Transportation Systems

(71) Applicant: Kasaine Ole Pertet, Bronx, NY (US)

(72) Inventor: Kasaine Ole Pertet, Bronx, NY (US)

(21) Appl. No.: 15/134,582

(22) Filed: Apr. 21, 2016

Related U.S. Application Data
(60) Provisional application No. 62/179,533, filed on May 11, 2015.

(51) Int. Cl. G06Q 20/32; H04W 12/06; H04W 4/80

(52) U.S. Cl. CPC G06Q 20/327; G06Q 2240/00; H04W 4/80; H04W 12/06

(57) ABSTRACT

A system for communicating in a transportation system is disclosed. A mobile device with a metro-application program in a communication link with a metro-station controller. The metro-station controller server communicates with the mobile device via the communication link, where the metro-station controller authenticates the mobile device based on the metro application program then the metro-station controller transmits the mobile device information to a metro-web server. The metro-station controller receives mobile device information where the metro-station controller compares the mobile device information with information stored on a database of the metro-web server, where if the mobile device information matches information stored in the database of the metro-web server then the mobile device is confirmed. The metro-web server transmits a message to the metro-station controller to allow the mobile device to access information on the metro-station controller to go through a turnstile.

### CROSS REFERENCE TO RELATED APPLICATION

This non-provisional patent application claims priority to a U.S. Provisional Patent Application No. 62/179,533 filed on May 11, 2015 which is incorporated herein by reference.

### FIELD OF THE INVENTION

The present invention relates to a systems and method for managing and handling transportation systems.

### BACKGROUND OF THE INVENTION

Generally, mobile phones have become ubiquitous in our society lending itself to be in the daily lives of many people. Most people utilize the myriad of applications on cell phones but there are some applications that haven't been developed. As it is now people are traveling from one place to another but there's no mobile device that has software application to allow a person to easily pass through a metropolitan transit station. Thus, there is a need for an application that allows a person to easily traverse through a Metropolitan transit station.

### SUMMARY OF THE INVENTION

The present invention has been accomplished in view of the above-mentioned technical background, and it is an object of the present invention to provide a system for managing a transportation system.

In a preferred embodiment of the invention, a system for managing transportation is disclosed. A mobile device with a metro application program in a communication link with a metro-station controller. The metro-station controller communicates with the mobile device via the communication link, where the metro-station controller authenticates the mobile device based on the metro application program then the metro-station controller server transmits the mobile device information to a metro-web server. The metro-web server receives mobile device information wherein the metro-web server compares the mobile device information with information stored on metro-web server database, where if the mobile device information matches information stored in a database of the metro-web server then the mobile device is confirmed. The metro web server transmits a message to the metro-station controller to allow the mobile device to access information on the metro-station controller.

### BRIEF DESCRIPTION OF THE DRAWINGS

These and other advantages of the present invention will become more apparent as the following description is read in conjunction with the accompanying drawings, wherein:

FIG. 1 is an illustration of a system for managing information in accordance with an embodiment of this invention;

FIG. 2 is a block diagram of an exemplary mobile device in accordance with an embodiment of the invention;

FIG. 3 is an illustration of a User Profile screen on mobile device in accordance with an embodiment of the invention; and

FIG. 4 is a flow-chart of how the system works in accordance with an embodiment of the invention,

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

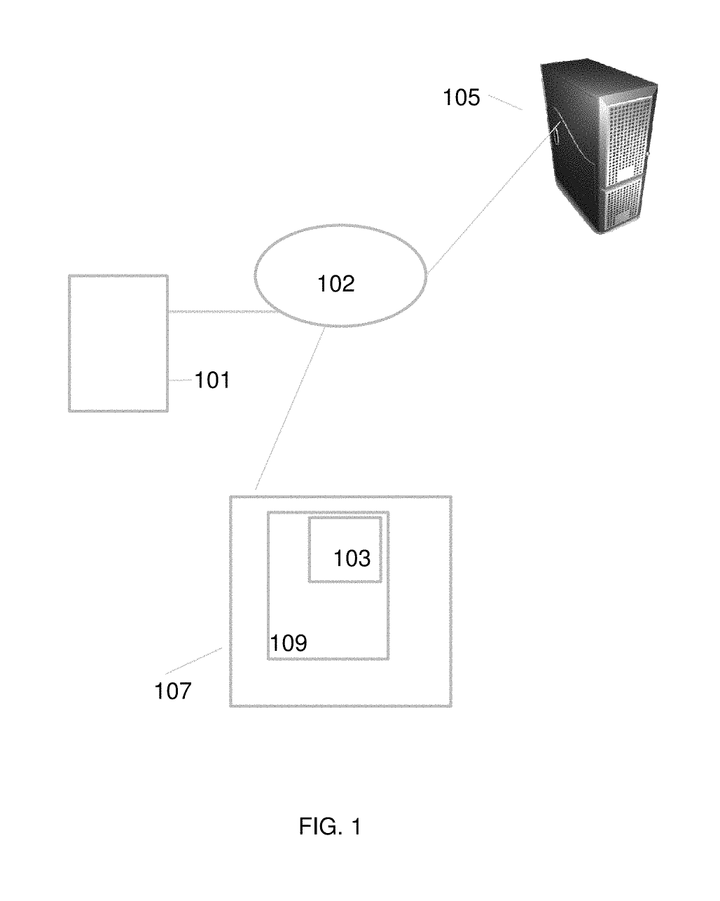

FIG. 1 is an illustration of a system for managing information in accordance with an embodiment of this invention. This system for managing information 100 includes: a mobile device 101, network 102, metro-station controller 103, a Metro web server 105. A Metro-station 107 and a turnstile system 109. Mobile device 101 is linked to a network 102. Network 102 or communication link is located within the metro-station 107. Metro-station 107 is a typical transit system as in major city in the United States of America or in the world, such as in New York City, Washington D.C., Los Angeles, London, Paris or Barcelona where there are several turnstiles, entrance/exit doors and a transit control booth.

Network 102 or communication link may be the Internet, or any wide-area network or combination of networks capable of supporting data transfer between devices of various interconnected devices to support wired, wireless or any two-way communication. The network 102 connects various devices including the metro-station controller 103 with the metro-web server 105.

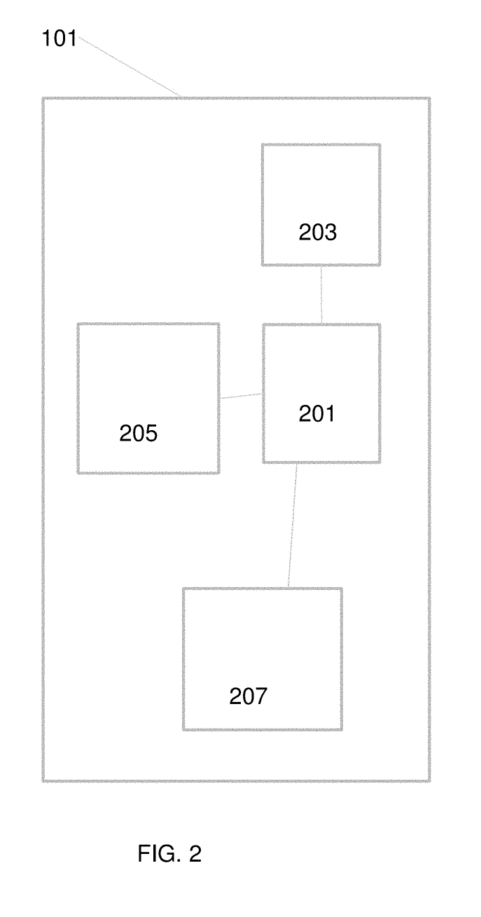

Mobile device 101 (FIG. 2) may be a smartphone, a cellular telephone, a tablet computer, a portable computer, a touch pad-based device, or any other suitable device. In an example, mobile device 101 includes a processor 201 or controller including instructions stored for the metro-application program thereon in a memory. The processor 201 may be implemented using any suitable microcontroller or microprocessor capable of executing instructions. Additionally, the processor 201 may include hardware implementations, such as application specific integrated circuits (ASIC), programmable logic devices (PLDs), or any other suitable logic device or devices. The processor 201 is coupled to data network connectivity 203, a secure element 205 and an NFC transceiver 207, e.g. a close-proximity communication device. Processor 201 includes the metro application program in order to manage and handle the transportation system 100.

This metro application program or computer program (also known as programs, software, software application or code) include machine instructions for a programmable processor, and can be implemented in a high-level procedural and/or object oriented programming language, and/or in assembly/machine language. As used herein, the terms “machine-readable medium” “computer-readable medium” refers to any computer program product, apparatus and/or devices (e.g., magnetic discs, optical disks, memory Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Metro-application program will be developed for IOS and the Android platform. This application will be used for maintaining tickets and representing/showing tickets to the metro-station controller 103 (FIG. 1). This application program on mobile device 101 will communicate through the metro-station controller 103 with the metro-web server 105 for getting the latest ticket information purchased by the user of the mobile device 101, getting current ticket balance of users etc. When the mobile device 101 user wants to use the metro-station controller 103 to obtain a ticket he/she will open the QR code ticket available from the metro-application program on the mobile device 101 to show to the scanner on the Metro-station controller 103. Initially, both metro application programs will support the QR code based tickets. NFC based ticket support will be added later on when IOS and Android provides software API for controlling NFC hardware available on smartphone. Metro application programs will have various screens as described

Mobile device 101 acts as a gateway for transmitting a mobile operator's data to the network 102. Mobile device 101 can support multiple communication channels for exchanging multimedia and other data with the metro web server 105 and other devices using a Wi-Fi LAN (e.g., IEEE 802.11 standard) for Internet access, a short-range Bluetooth wireless connection for point-to-point access, and/or an NFC channel for close-proximity access.

Referring to FIG. 2, the data network connectivity 203 may be implemented using any wireless communication technique. For example, the data network connectivity 203 may be hardware or software, or both, that facilitate connection to a digital cellular network. Additionally or alternatively, the data network connectivity 203 may facilitate communication with 802.xx type networks or any other suitable data networks. Thus, the data network connectivity 203 may provide the cellular and wired fidelity (Wi-Fi) data connectivity that is typically found in smartphones.

Secure element 205 stores information related to payment methods, or any other secure information. For example, the secure element 205 may store information related to credit card or accounts, debit cards or accounts, customer loyalty card or account or any other suitable information. The secure element 205 may also store security codes, security keys, or any other suitable information that may be used to facilitate transactions between the mobile device 101 and a point of sale terminal.

Returning to FIG. 1, the metro station 107 includes a metro-station controller 103, which may be located at place in the metro station 107, is an electronic device placed at an Entry point of a Public transportation system, which has the capability to read/scan QR code/NFC based tickets on mobile device 101 and validate it with Metro web server 105. The Metro-station controller 103 may also be any typical computer or web-server that receives and analyzes computer related information. Also, the metro-station controller 103 communicates with the metro-web server 105 over Internet or network 103 using http/https protocol. There may be multiple metro-station controllers 103 placed at the entry of the metro-station 107 depending upon the user needs served by this system for managing transportation information 100.

Metro-station controller 103 is an Embedded Linux based Electronic system which has feature like QR code/NFC scanner/reader, Internet connectivity through Ethernet/Wi-Fi/3G/4G media, opening turning style gate controller, alarm and many other features. Also, metro-station controller 103 includes a code reader or scanner. This reader may be capable of reading and/or decoding for example, a barcode, a radiofrequency identification code (RFID), or a “Quick Response” (QR) code, and/or receiving signals, such as NFC signals, audio signals, or infrared signals.

The Metro-station controller 113 will have Ethernet connectivity. When this system 100 is used at the Metropolitan Transit Association (MTA) 107 station it will be able to communicate with the metro-web server 105 using http/https connectivity. When used on an MTA bus, Internet connectivity to the Metro-station controller 103 will be provided using the external 3G to Ethernet converter. Metro-station controller 103 will require continuous Internet connectivity for authenticating user and tickets with Metro web server 105.

LSR118 QR code/NFC reader will be integrated into the mobile device 101, metro-station controller 103 and Metro-web server 105. LSR118 reads 2D barcodes including QR codes from smart phones, tablets, and paper in less than one second. LSR118 also has the capability to read contacts less NFC from smart phones, tablets, smart cards. It is a rugged, dust-proof and water resistant sensor. The sensor is already in use at Marylebone Station, London.

Metro-station controller 103 also has RS232 communication port. RS232 communication port is used to command an access gate controller or turnstile system controller. When embedded Linux based SBC verifies correct user ticket, it will send OPEN command to access gate controller or turnstile system controller. RS232 communication port is also used to communicate with LSR118 QR code/NFC reader. Whenever LSR118 QR code/NFC reader will detect any MCS ticket via QR code from mobile app or NFC from mobile app, it will send signal to embedded Linux based SBC to verify detected MCS ticket.

Metro-web server 105 and its interface will be running on a software server similar to Amazon. The metro-station controller 103 will be communicating with the metro-web server 105 to verify the user of the mobile device 101's ticket. The metro-web interface will provide a user to also purchase a Metro-card Ticket online. A Metro-database is stored on the metro-web server 105 that is an online database stored on a software server similar to Amazon. This database will have all of the information related to a user, the mobile information of a user, the credit/debit card payment information of the user, the system all transaction details, train schedules and Metro-card information. Metro-web server 105 stores information base on the action taken by a user. Initially, the metro-database to a typical MTA database or a derivation of this database.

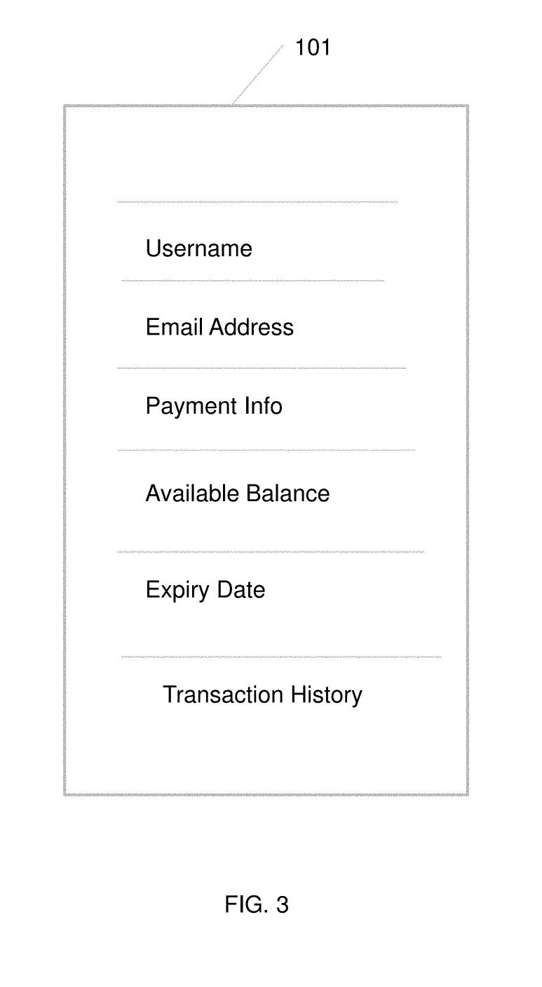

FIG. 3 is an illustration of a user Profile screen of the mobile device in accord with this invention. This user profile screen is part of the metro-application program described above. Mobile device 101 includes a user profile screen 301. The User profile screen 301 may include the following: User basic information, Payment information, Available balance, Expiry date, Transaction history, Ride History and Change password. This User profile screen 301 is an exemplary version of the user profile screen that may be changed according to the metro-application program.

The user basic information may include: User name, gender of the mobile device owner, telephone number of mobile device, email address and address of mobile device user. The payment information may include: credit card number of mobile device owner, PayPal information and any other payment processing information. The user of the mobile device 101 can save his/her payment method within this metro-application program securely and will be used by the user to recharge his/her account with rides. By using the credit card payment method the use will need to fill out his/her credit card number, expiration date, CVV number and it will navigate to credit card payment processor page and will charge his/her credit card and his/her account will get recharge with MTA rides based on which option they selected from the program.

The available balance will be used by a user to check how much money remained in his/her account so he can check available balance before he/she travels. The expiry date or expiration date is the date until which card should be used otherwise it will not be useable after the expiry date. The transaction history will be a transaction log to checkout who made transaction in the past. The ride history will show data of taken MTA rides with date/time and pickup location. The change password will be used to change password of application account.

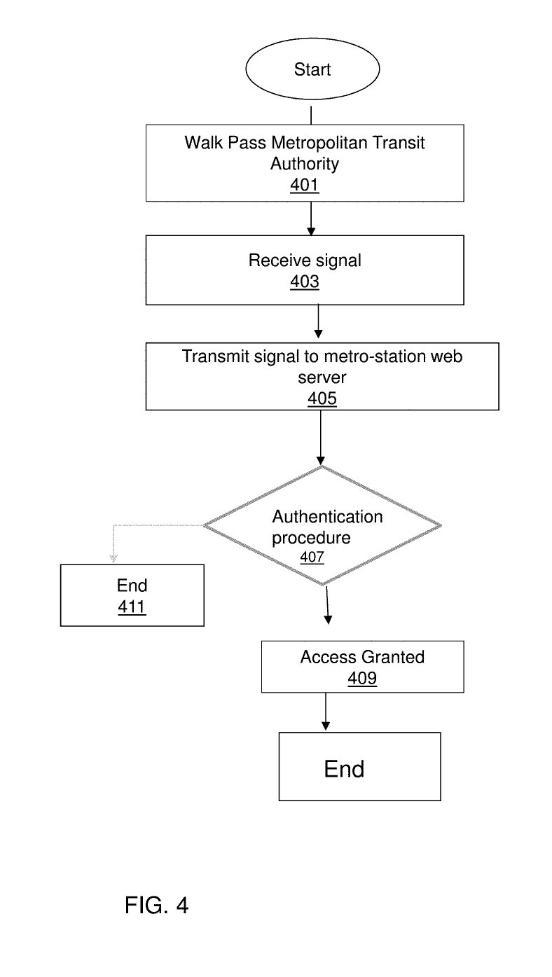

FIG. 4 is a flow chart of how this system works. At block 401 a person with a mobile device 101 walks into a Metropolitan Transit Authority (MTA) station 107 where she walks pass a turnstile or entrance/exit door or gate that is connected to a metro-station controller 103 then the person puts the face of the mobile device 101 in front of the metro-station controller 103 that communicates via the Internet 102 with the metro-station controller 103. At block 403, the metro-station controller 103 receives a signal (QR, NFC signal etc.) from the Mobile device 101.

Next, at block 405, the metro-station controller 103 transmits the received signal through the Internet 102 from the mobile device 101 to the metro-web server 105. At block 407, the metro-web server 105 goes through an authentication procedure to review if the info in the signal is associated with mobile device 101 to find out if the information is similar to mobile device 101 stored on its database to provide access to the metro-station controller 103. If yes, then at block 409 the person with the mobile device 101 can go through the turnstile system at the MTA, go through the turnstile or entrance/exit door or gate, check his balance, add a ride to his current status, select a package etc. If no then at block 411 the person with mobile device 101 is prohibited from going through the turnstile system or entrance gate or door associated with the metro-station controller 103 then the process ends.

This invention provides a simple system for managing transportation. A mobile device with a metro application program in a communication link with a metro-station controller. The metro-station controller communicates with the mobile device via the communication link, where the metro-station controller authenticates the mobile device based on the metro application program then the station metro-station controller transmits the mobile device information to a metro-station controller. The metro-station controller receives mobile device information wherein the metro-station controller compares the mobile device information with information stored on a metro-web server database, where if the mobile device information matches information stored in the metro web server database then the mobile device is confirmed. The metro controller server transmits a message to the station connection server to allow the mobile device to access information on the metro-web server.

Although the present invention has been described above in terms of specific embodiments, many modifications and variations of this invention can be made as will be obvious to those of ordinary skill in the art, without departing from its spirit and scope as set forth in the following claims.

What is claimed is:

1. A system for communicating in a transportation system comprising:
a mobile device with a metro-application program in a communication link with a metro-station controller;
the metro-station controller server communicates with the mobile device via the communication link, wherein the metro-station controller authenticates the mobile device based on the metro application program then the metro-station controller transmits the mobile device information to a metro-web server;
the metro-station controller receives mobile device information wherein the metro-station controller server compares the mobile device information with information stored on a database of the metro-web server, wherein if the mobile device information matches information stored in the database of the metro-web server then the mobile device is confirmed; and
the metro-web server transmits a message to the metro-station controller to allow the mobile device to access information on the metro-station controller to go through a turnstile.

2. The system of claim 1 wherein the communication link is an Internet network.

3. The systems of claim 1 wherein the communication link is an NFC signal.

4. The system of claim 1 wherein the communication link is a QR code.

5. The system of claim 1 wherein the metro application program on the mobile device is able to access mobile information on the metro-station controller.

6. The system of claim 1 wherein the metro-station controller provides access to a user of the mobile device to go through an entrance gate.
